(19) United States
(12) Patent Application Publication
(10) Pub. No.: US 2005/0067725 A1
(43) Pub. Date: Mar. 31, 2005

(54) Method for manufacturing artificial eyes

(76) Inventor: Hsiang Ming Hsu, Da Li City (TW)

Correspondence Address: Hsiang Ming HSU, P.O.Box 63-99, Taichung, 406, TW

(21) Appl. No.: 10/673,297

(22) Filed: Sep. 26, 2003

(51) Int. Cl. B29D 11/00

(52) U.S. Cl. 264/1.32

(57) ABSTRACT

A method for manufacturing artificial eyes includes forming a recess in a shell, disposing a sheet member having a pattern or veins into the recess of the shell. A lens is then disposed into the recess of the shell and engaged onto the sheet member, and heated to secure the lens and the sheet member in the recess of the shell. A cavity is formed in the lens to form a spatial pupil for the lens, and a color material is applied into the cavity of the lens, before disposing the lens into the recess of the shell. The shell and the sheet member may be heated to secure the veins of the sheet member onto the shell.

### BACKGROUND OF THE INVENTION

1. Field of the Invention

The present invention relates to a method for manufacturing artificial eyes, and more particularly to a method for manufacturing artificial eyes having spatial pupil or iris or lens.

2. Description of the Prior Art

Various kinds of typical methods have been developed and provided for manufacturing artificial eyes, and comprise providing a separate disc to simulate the iris of the human eyes.

For example, U.S. Pat. No. 1,373,579 to Wendtland, U.S. Pat. No. 1,740,675 to Wilhelm, U.S. Pat. No. 1,993,121 to Travers, and U.S. Pat. No. 2,394,400 to Noles disclose three of the typical artificial eyes each having a different structure to simulate the iris of the human eyes.

However, in the typical artificial eyes, the pupil and the veins for simulating the suspensory ligaments are normally provided and disposed in the same plan or level and thus having a planar structure, such that the typical artificial eyes may not vividly simulate the iris and/or the lens of the human eyes.

The present invention has arisen to mitigate and/or obviate the afore-described disadvantages of the conventional methods for manufacturing artificial eyes.

### SUMMARY OF THE INVENTION

The primary objective of the present invention is to provide a method for manufacturing artificial eyes having a spatial pupil or iris or lens for vividly simulating the pupil and/or the lens of the human eyes.

In accordance with one aspect of the invention, there is provided a method for manufacturing artificial eyes comprising providing a shell having a recess formed therein, disposing a sheet member into the recess of the shell, the sheet member including veins provided therein, disposing a lens into the recess of the shell and engaged onto the sheet member, and heating the shell and the lens, to secure the lens and the sheet member in the recess of the shell.

It is preferable that a cavity is formed in the lens, to form a spatial pupil for the lens. The cavity of the lens preferably includes a semi-spherical shape or structure. A color material is preferably applied into the cavity of the lens, before disposing the lens into the recess of the shell.

It is preferable that the shell and the sheet member are heated to secure the veins of the sheet member onto the shell. A color base material is preferably applied into the recess of the shell, before disposing the sheet member into the recess of the shell. It is preferable that the shell and the color base material are heated to secure the color base material onto the shell.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a schematic view illustrating procedures of a method for manufacturing artificial eyes in accordance with the present invention;

FIG. 2 is a flow chart, illustrating the procedures of the method for manufacturing the artificial eyes;

FIG. 3 is a schematic view illustrating procedures of the method for manufacturing the cornea of the artificial eyes; and

FIG. 4 is a schematic view similar to FIG. 1, illustrating simplified procedures of the method for manufacturing the artificial eyes.

### DETAILED DESCRIPTION OF THE PREFERRED EMBODIMENT

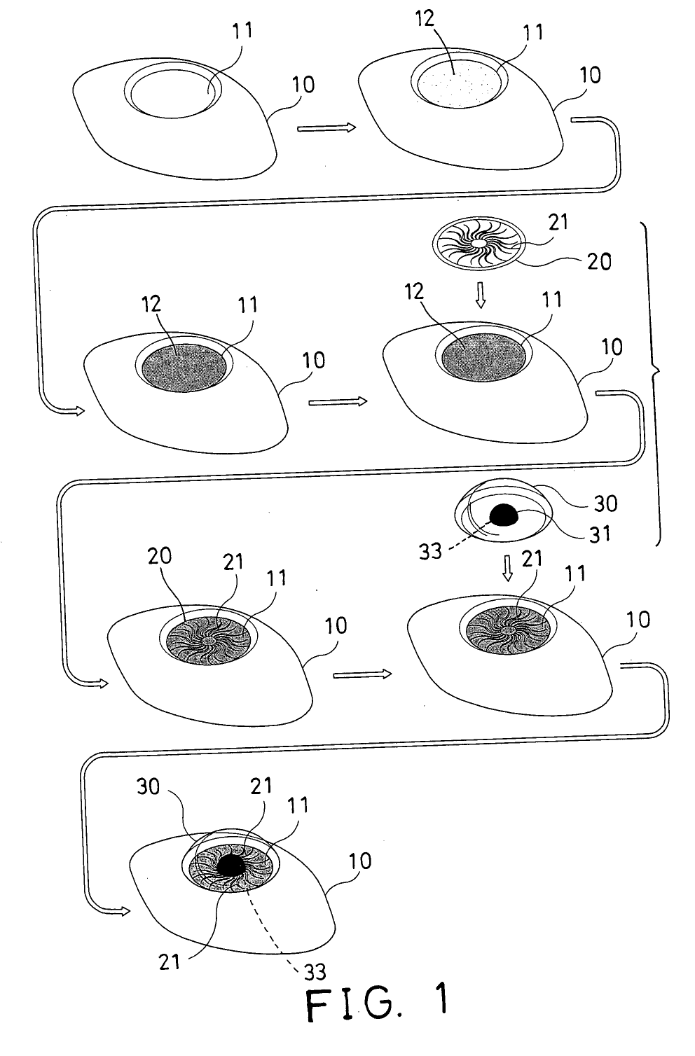

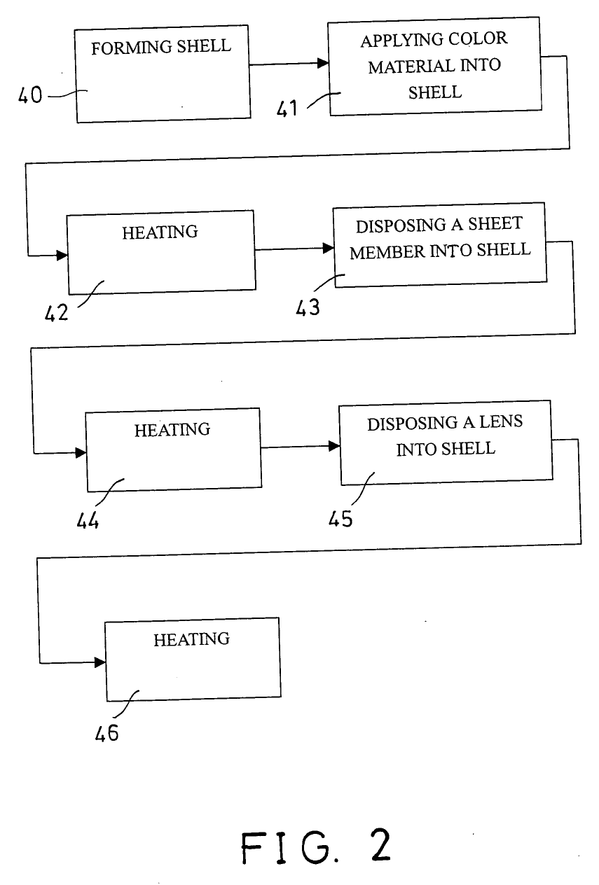

Referring to the drawings, and initially to FIGS. 1-2, a method for manufacturing artificial eyes in accordance with the present invention comprises providing or forming a shell 10, by such as typical molding procedures, in process 40. The shell 10 is normally made of white color materials, and includes a circular recess 11 formed in the upper portion thereof.

A color base material 12, such as enamel material 12 is applied or filled into the circular recess 11 of the shell 10 in process 41, and is heated to about 700-750° C. in process 42, in order to cure or attach or secure the color base material 12 onto the shell 10, and so as to form or to apply a color for forming or simulating the iris of the human eyes, for example.

A sheet member 20 is then disposed into the circular recess 11 of the shell 10 in process 43, and includes a pattern or veins 21 formed or provided therein for forming or simulating the suspensory ligaments of the human eyes. The sheet member 20 is preferably made of organic glue materials, synthetic materials, or the like.

The shell 10 and the sheet member 20 are then further heated to out 700-750° C in process 44, in order to cure or attach or secure e sheet member 20 onto the shell 10, and so as to form or to apply e pattern or veins 21 onto the shell 10, and to form or to simulate he suspensory ligaments of the human eyes.

A spatial lens 30 is disposed into the circular recess 11 of the hell 10 in process 45, or engaged onto the sheet member 20, and he shell 10 and the lens 30 are then further heated to about 750-800° C. in process 46, in order to cure or attach or secure the spatial lens 30 onto the shell 10, and so as to form or to simulate the cornea of the human eyes.

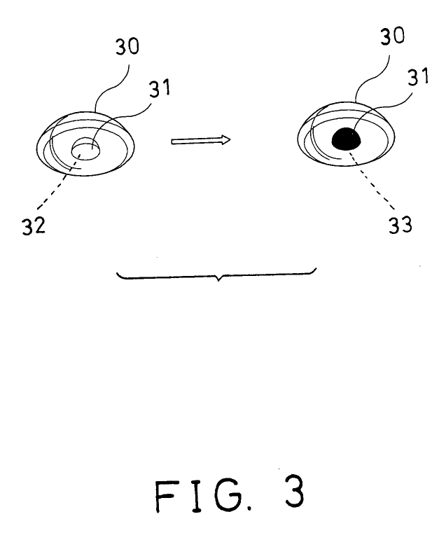

As shown in FIG. 3, the spatial lens 30 includes a semi-spherical shape or structure and may be made of or formed with glass materials, synthetic materials, or the like, by such as typical molding procedures. The spatial lens 30 may be made of glass or synthetic materials having various colors, for forming colorful cornea or iris of the human eyes.

The spatial lens 30 includes a cavity 31 formed therein and having such as a semi-spherical shape or structure and defined by a concave inner peripheral surface 32, and a color material 33 is then applied into the concave inner peripheral surface 32 of the lens 30, for forming or simulating the pupil of the human eyes.

It is to be noted that the concave inner peripheral surface 32 of the lens 30 and the color material 33 applied into the concave inner peripheral surface 32 of the lens 30 include a spatial shape or structure so as to vividly simulate the pupil and/or the lens of the human eyes.

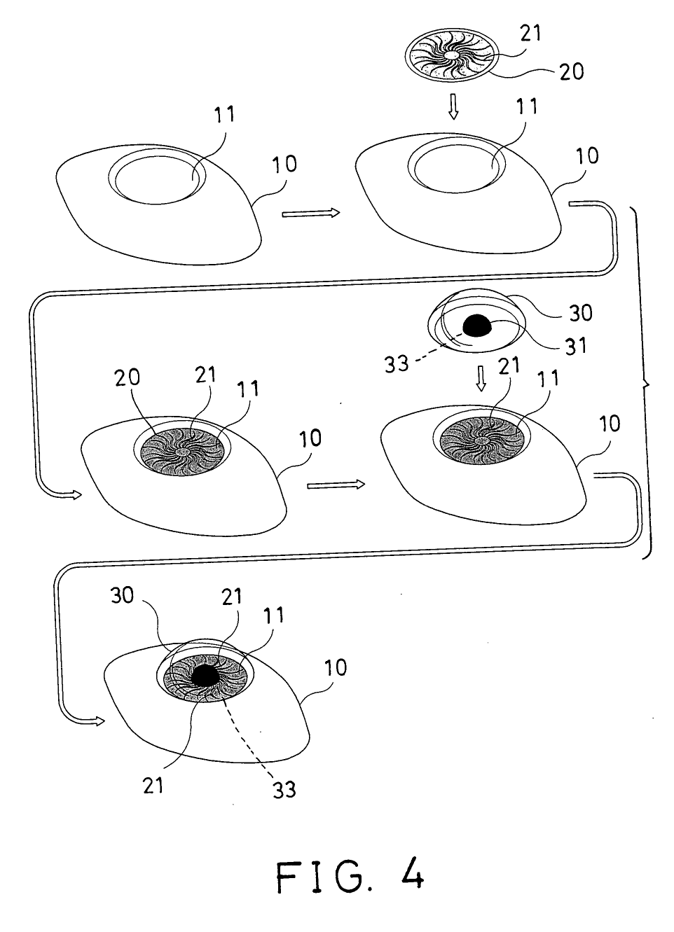

As shown in FIG. 4, without applying the color base material 12 into the circular recess 11 of the shell 10 (process 41), and without the heating process 42, the sheet member 20 may also be directly disposed into the circular recess 11 of the shell 10 and heated and secured to the shell 10.

Alternatively, the sheet member 20 and the lens 30 may also be directly disposed into the circular recess 11 of the shell 10 and heated and secured to the shell 10 in one step. The spatial or concave inner peripheral surface 32 of the lens 30 and the color material 33 may also be used to vividly simulate the pupil and/or the lens of the human eyes.

Accordingly, the method for manufacturing artificial eyes in accordance with the present invention includes a spatial pupil or iris or lens for vividly simulating the pupil and/or the lens of the human eyes.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A method for manufacturing artificial eyes comprising:
providing a shell having a recess formed therein,
disposing a sheet member into said recess of said shell, said sheet member including veins provided therein,
disposing a lens into said recess of said shell and engaged onto said sheet member, and
heating said shell and said lens, to secure said lens and said sheet member in said recess of said shell.

2. The method for manufacturing artificial eyes as claimed in claim 1 further comprising forming a cavity in said lens, to form a spatial pupil for said lens.

3. The method for manufacturing artificial eyes as claimed in claim 2, wherein said cavity of said lens is a semi-spherical cavity.

4. The method for manufacturing artificial eyes as claimed in claim 2 further comprising applying a color material into said cavity of said lens, before disposing said lens into said recess of said shell.

5. The method for manufacturing artificial eyes as claimed in claim 1 further comprising heating said shell and said sheet member, to secure said veins of said sheet member onto said shell.

6. The method for manufacturing artificial eyes as claimed in claim 1 further comprising applying a color base material into said recess of said shell, before disposing said sheet member into said recess of said shell.

7. The method for manufacturing artificial eyes as claimed in claim 6 further comprising heating said shell and said color base material, to secure said color base material onto said shell.
